(19) United States
(12) Patent Application Publication
(10) Pub. No.: US 2023/0348817 A1
(43) Pub. Date: Nov. 2, 2023

(54) LIQUID DETERGENT FORMULATION

(71) Applicant: The Procter & Gamble Company, Cincinnati, OH (US)

(72) Inventors: Patrick Christopher Stenger, Fairfield, OH (US); Rachel Marie Applegate, Loveland, OH (US)

(21) Appl. No.: 17/730,540

(22) Filed: Apr. 27, 2022

(51) Int. Cl. C11D 1/83; C11D 11/00

(52) U.S. Cl. CPC C11D 1/83; C11D 11/0017; C11D 1/72

(57) ABSTRACT

Liquid laundry detergent compositions can include about 15% or less of surfactant, wherein the surfactant includes a nonionic alcohol ethoxylate surfactant with an average carbon chain length of about 13 to about 15 and an average level of ethoxylation of about 6.8 to about 8.25.

### FIELD OF THE INVENTION

Liquid laundry detergent compositions with a pourable viscosity which include about 15% or less of total surfactant, a nonionic alcohol ethoxylate surfactant, an anionic surfactant, and water.

### BACKGROUND OF THE INVENTION

Liquid detergent compositions are routinely used to wash substrates, like fabric. The formulation of a liquid detergent composition is a balance, among other things, of the ability to sufficiently clean the target substrate without damaging the substrate being cleaned. The cleaning aspect can be especially difficult for those formulations which have a lower level of surfactant. It can also be difficult to formulate at these lower surfactant levels and still have a consumer desirable pour viscosity. Compositions with low levels of surfactant are often very thin and pour like water. Consumers can see these low viscosity compositions as inferior to higher viscosity compositions even though they may clean as well or better than those with a higher viscosity. Thus, it is beneficial to formulate lower surfactants formulations in a way that will give a composition with a consumer preferred viscosity and there is a need for such formulations.

### SUMMARY OF THE INVENTION

Included herein for example is a liquid detergent composition comprising: a) from about 0.5% to about 15%, of surfactant; wherein the surfactant comprises an anionic surfactant, and a nonionic alcohol ethoxylate surfactant with an average carbon chain length of about 13 to about 15 and an average level of ethoxylation of about 6.8 to about 8.25; and b) water; wherein the ratio by weight of the nonionic alcohol ethoxylate surfactant to the anionic surfactant is from about 0.8:1 to about 5:1, and the viscosity of the liquid detergent composition is from 250 cP to about 800 cP, when measured at 25° C. at 20/s.

Also included herein, for example, is a liquid laundry detergent composition comprising: a) from about 5% to about 15%, by weight of the composition, of surfactant; wherein the surfactant comprises: i) an anionic surfactant, and ii) a nonionic alcohol ethoxylate surfactant with an average carbon chain length of about 13 to about 13.5 and an average level of ethoxylation of about 6.8 to about 7.5; a nonionic alcohol ethoxylate surfactant with an average carbon chain length of about 13.5 to about 14 and an average level of ethoxylation of about 6.8 to about 7.75; a nonionic alcohol ethoxylate surfactant with an average carbon chain length of about 14.25 to about 15 and an average level of ethoxylation of about 6.8 to about 8.2; and b) water.

Also included herein, for example, is a liquid laundry composition comprising: a) from about 5% to about 15% by weight of the composition of surfactant, wherein the surfactant comprises: from about 3% to about 13% by weight of the composition of a nonionic alcohol ethoxylate surfactant with an average carbon chain length of about 13 to about 15 and an average level of ethoxylation of about 6.8 to about 8.25; from about 1% to about 5% by weight of the composition of a linear alkyl benzene sulfonate surfactant; and from about 0.1% to about 1% by weight of the composition of an amine oxide; and b) water; wherein the composition has a viscosity of about 350 cP to about 800 cP when measured at 25° C. at 20/s and the ratio by weight of the nonionic alcohol ethoxylate surfactant to the alkyl benzene sulfonate surfactant is from about 1.5:1 to about 4:1.

These and other incarnations will be more fully described throughout the specification.

### BRIEF DESCRIPTION OF THE DRAWINGS

FIG. 1 is a graph showing the average carbon chain length (Y-axis) and the average level of ethoxylation (X-axis) on nonionic alcohol ethoxylate surfactants and how they correspond to a preferred or non-preferred pour viscosity.

### DETAILED DESCRIPTION OF THE INVENTION

Viscosity can be an important aspect of a liquid laundry detergent composition. This can be true for production and transport, but there is also a consumer preference component. So, even if a certain viscosity will work from a manufacturing and use standpoint it may not be acceptable to a consumer. A thin, waterlike viscosity in a product can be viewed as a product of low quality and one that is easily spilled, even if that is not the case.

Generally speaking, the more surfactant a formula has, the easier it is to build viscosity in that product. This is usually true for those products which have at least 18% surfactant. In fact, at much higher levels of surfactant (40% or more) the opposite can be the issue, i.e. the viscosity can be too high and need to be reduced to allow for transport and/or processing. Thus, for liquid laundry detergent compositions with low levels of surfactant (about 15% or less), it can be difficult to build viscosity.

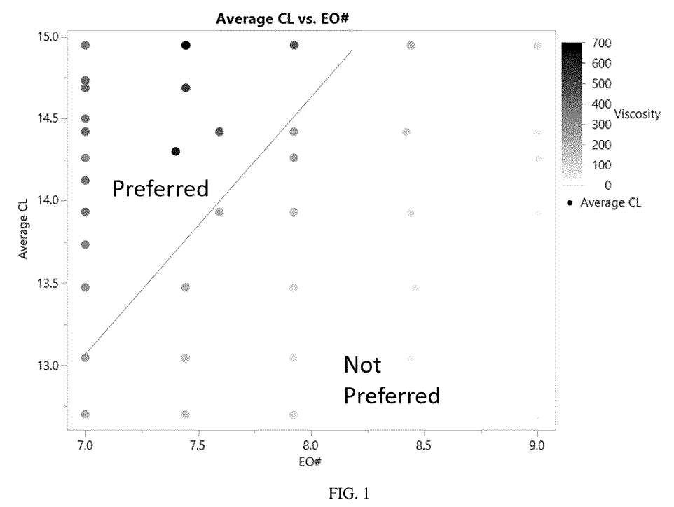

In addition to the surfactant level, the types of surfactants can impact the viscosity of a liquid laundry detergent product. Surprisingly, when formulating predominantly with nonionic alcohol ethoxylate surfactants, it has been found that both the average carbon chain length and the average level of ethoxylation of those surfactants can impact the viscosity of a liquid laundry detergent composition. Looking at FIG. 1, a liquid detergent composition is made where the nonionic alcohol ethoxylate surfactant is substituted as illustrated by the data points represented by dots. As can be seen on FIG. 1, as the level of ethoxylation increases from about 6.8 to about 8.25 in combination with an average carbon chain length of about 13 to about 15, a preferred viscosity is achieved (about 350 cP to about 700 cP). However, even when staying within an average carbon chain length of about 13 to about 15, when going above an average level of ethoxylation of about 8.25, the viscosity drops to an unpreferred range (<250 cP). Based on the data collected, it is believed the nonionic alcohol ethoxylates which will exhibit this behavior can be defined by the following formula: Average Chainlength≥1.6*(Average EO−7)+13.

Without being limited by theory, it is believed this could be the result of certain nonionic alcohol ethoxylate surfactants forming wormlike micelles within the liquid laundry detergent formulation. At a high shear (about 500 (1/s) or more) the viscosity of some of the nonionic alcohol ethoxylate surfactants starts to drop. Those three materials which show this phenomenon (NI 45-7, having an average carbon chain length of about 14-15 and average ethoxylation of about 7; NI 5-7 having an average carbon chain length of about 15 and average ethoxylation of 7; and NI 5-7.4 having an average carbon chain length of about 15 and average ethoxylation of about 7.4) also correspond to points on the graph of FIG. 1 in the preferred viscosity range.

Liquid Detergent Composition

A liquid detergent composition can include, for example, from about 0.5% to about 15% by weight of total surfactant. In addition, the composition can include from about 1% to about 15%, from about 2% to about 15%, from about 3% to about 15%, from about 4% to about 15%, from about 5% to about 15%, from about 6% to about 15%, from about 7% to about 15%, from about 8% to about 15%, from about 9% to about 15%, or from about 10% to about 15%, by weight of the composition of total surfactant.

A liquid detergent composition can have a viscosity of about 250 cP to about 800 cP, from about 300 cP to about 800 cP, or from about 350 cP to about 800 cP. Viscosity can be measured in accordance with known viscosity methods. One way to measure the viscosity is described below. This can be correlated to a pour viscosity.

The surfactant can comprise an anionic surfactant, a nonionic surfactant, a cationic surfactant, a zwitterionic surfactant, an amphoteric surfactant, an ampholytic surfactant, or a combination thereof. The surfactant may be a combination of surfactants where the predominant surfactant is nonionic. By predominant, it is meant that the material is the largest by weight of like materials. For example, the predominant surfactant would have the largest weight percentage of surfactants in the composition, by weight of the total surfactant.

The nonionic surfactant may be present in an amount of about 0.5% to about 15%, by weight of the composition. In addition, the composition can include from about 1% to about 15%, from about 2% to about 15%, from about 3% to about 15%, from about 4% to about 15%, from about 5% to about 14%, from about 6% to about 14%, from about 3% to about 13%, from about 7% to about 13%, from about 7% to about 12%, from about 7% to about 11%, or from about 8% to about 10%, by weight of the composition of a nonionic surfactant.

The nonionic surfactant can comprise an alcohol ethoxylate surfactant. The alcohol ethoxylate surfactant can comprise an average carbon chain length of the hydrophobe of about 13 to about 15 carbons. In addition, 95% or more by weight of the alcohol ethoxylate surfactant can comprise carbon chain lengths of the hydrophobe of C11 to C16. The nonionic surfactant can comprise an average level of ethoxylation of about 6.8 to about 8.25, or about 7 to about 8.

The a nonionic alcohol ethoxylate surfactant can have an average carbon chain length of about 13 to about 13.5 and an average level of ethoxylation of about 6.8 to about 7.5; an average carbon chain length of about 13.5 to about 14 and an average level of ethoxylation of about 6.8 to about 7.75; an average carbon chain length of about 14.25 to about 15 and an average level of ethoxylation of about 6.8 to about 8.2, or a combination thereof.

The nonionic alcohol ethoxylate can have an average carbon chain length of the hydrophobe and a level of ethoxylation as follows, for example, an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.

Some commercially available materials which can be utilized as a nonionic alcohol ethoxylate herein can include: Neodol® 45-7, Neodol® 45-6.8, Neodol® 25-7, Neodol® 135-7, Neodol® 25-7, Novel® 14/16-7, Lialet™ 125-7, Slovasol™ 257, Slovasol™ 457, Slovasol™ 458, Lialet™ 145-8, and combinations thereof.

An anionic surfactant may be included in the liquid detergent composition. The anionic surfactant may be included at a level of about 0.1% to about 9%. In addition, the composition can include from about 0.1% to about 8%, from about 0.2% to about 7%, from about 0.3% to about 6%, from about 0.4% to about 5.5%, from about 0.5% to about 5%, from about 0.6% to about 5%, from about 0.7% to about 5%, from about 0.8% to about 5%, from about 0.9% to about 4%, or from about 2% to about 4%, by weight of the composition of an anionic surfactant. The liquid detergent composition can have a ratio by weight of the nonionic alcohol ethoxylate surfactant to the anionic surfactant of about 0.8:1 to about 5:1, about 1.5:1 to about 4:1, or about 2.5:1 to about 3:1.

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group. The water solubilizing group may include, for example, a sulfonate, a sulphate, and/or a carboxylate so as to form a water-soluble compound. Usually, the hydrophobic group will comprise a C8-C22 alkyl, or acyl group. Such surfactants are usually employed in the form of water-soluble salts and the salt-forming cation usually is selected from sodium, potassium, ammonium, and magnesium, with the sodium being the most common.

Anionic surfactants may exist in an acid form, and said acid form may be neutralized to form a surfactant salt which is desirable for use in a liquid detergent composition. Typical agents for neutralization include the metal counterion base such as hydroxides, e.g., NaOH or KOH. Further agents for neutralizing anionic surfactants in their acid forms can include ammonia, amines, oligoamines, or alkanolamines. Suitable non-limiting examples of alkanolamines include monoethanolamine, diethanolamine, triethanolamine, and other linear or branched alkanolamines known in the art; for example, preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Suitable sulphonate surfactants can include methyl ester sulphonates, alpha olefin sulphonates, alkyl benzene sulphonates, especially alkyl benzene sulphonates, preferably C₁₀₋₁₃ alkyl benzene sulphonate, more preferably C12 alkyl benzene sulfonate. Suitable alkyl benzene sulphonate (LAS) is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, DETAL-PLUS catalyzed process, although other synthesis routes, such as HF, and other alkylation catalysts such as zeolites ZSM-4, ZSM-12, ZSM-20, ZSM-35, ZSM-48, ZSM-50, MCM-22, TMA offretite, TEA mordenite, clinoptilolite, mordenite, REY and zeolite Beta may also be suitable. In one aspect a magnesium salt of LAS is used.

The composition may comprise, for example, from about 0.1% to about 7%, from about 0.1% to about 6%, from about 0.5% to about 5%, from about 1% to about 5%, from about 2% to about 5%, or from about 2% to about 4%, by weight, of alkyl benzene sulphonate, like linear alkyl benzene sulphonate. The alkyl benzene sulphonate may comprise an alkyl benzene sulfonic acid, an alkali metal or amine salt of a C10-16 alkyl benzene sulfonic acid. The alkyl benzene sulphonate may comprise greater than 50% C12, preferably greater than 60% C12, preferably greater than 70% C12, and more preferably greater than 75% C12.

The anionic surfactant may comprise a sulphate surfactant. Suitable sulphate surfactants may include an alkyl sulphate. The alkyl sulphate may be a C₈₋₁₈ alkyl sulphate, for example. The alkyl sulphate may be a predominantly C₁₂ alkyl sulphate. The alkyl sulphate may be, for example, a middle cut alcohol based on palm kernel feedstock, coconut feedstock, or a combination thereof. A middle cut alcohol may include, for example, a C₁₂ blended with a C₁₄, C₁₆, C₁₈, or a combination thereof. On specific example of a middle cut alcohol is a C₁₂/C₁₄/C₁₆/C is blend with a weight ratio of 67/26/6/1.

The alkyl sulphate may also comprise a branched 2-alkyl primary alcohol sulphate. Branched 2-alkyl primary alkyl alcohol sulphates and 2-alkyl primary alkyl alcohol ethoxy sulphates having specific alkyl chain length distributions, can provide increased stain removal (particularly in cold water). 2-alkyl branched alcohols (and the 2-alkyl branched alkyl sulphates and 2-alkyl branched alkyl ethoxy sulphates and other surfactants derived from them) are positional isomers, where the location of the hydroxymethyl group (consisting of a methylene bridge (—CH₂— unit) connected to a hydroxy (—OH) group) on the carbon chain varies. Thus, a 2-alkyl branched alkyl alcohol is generally composed of a mixture of positional isomers.

Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The detergent composition can comprise a mixture of surfactant isomers of Formula I and surfactants of Formula II:

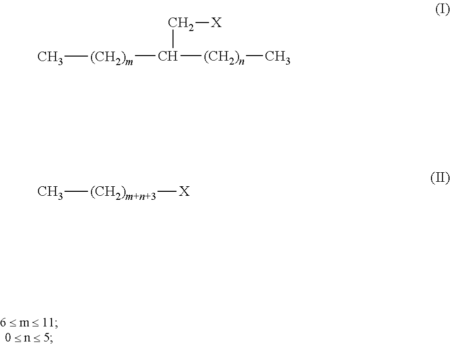

wherein from about 50% to about 100% by weight of the first surfactant are isomers having m+n=11; wherein from about 25% to about 50% of the mixture of surfactant isomers of Formula I have n=0; wherein from about 0.001% to about 25% by weight of the first surfactant are surfactants of Formula II; and wherein X is a hydrophilic moiety.

X can be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be, for example, a sulphate.

The sulphate surfactant may comprise an alkyl alkoxylated sulphate. The alkyl alkoxylated surfactant may be a C₈₋₁₈ alkyl alkoxylated sulphate, for example a C₈₋₁₈ alkyl ethoxylated sulphate. The alkyl alkoxylated sulphate can have an average degree of alkoxylation of from 0.5 to 20, preferably from 0.5 to 10, preferably from 0.5 to 5, more preferably from 0.5 to 3, from about 1.5 to 3, or from about 1.8 to 2.5. The alkyl alkoxylated sulphate may have a broad alkoxy distribution or a peaked alkoxy distribution. The alkyl portion of the alkyl ethoxylated surfactant may include, on average, from 13.7 to about 16 or from 13.9 to 14.6 carbons atoms. The alkyl ethoxylated surfactant may have at least about 50% or at least about 60% of an alkyl portion having 14 or more carbon atoms, preferably from 14 to 18, or from 14 to 17, or from 14 to 16, or from 14 to 15 carbon atoms.

The alkyl sulphate, alkyl alkoxylated sulphate and alkyl benzene sulphonates may be linear or branched, including 2-alkyl substituted or mid chain branched type, substituted or unsubstituted, and may be derived from petrochemical material or biomaterial. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulphated anionic surfactant used in the detergent of the invention. Most preferably the branched sulphated anionic surfactant is selected from alkyl sulphates, alkyl ethoxy sulphates, and mixtures thereof.

Alkyl sulphates and alkyl alkoxy sulphates are commercially available with a variety of chain lengths, ethoxylation and branching degrees. Commercially available sulphates include those based on Neodol alcohols ex the Shell company; Lial, Isalchem, Safol, Nacol®, Nafol®, Isofol®, and Marlipal® ex the Sasol company; and natural alcohols ex The Procter & Gamble Chemicals company.

Other suitable anionic surfactants include alkyl ether carboxylates, comprising a C10-C26 linear or branched, preferably C10-C20 linear, most preferably C16-C18 linear alkyl alcohol and from 2 to 20, preferably 7 to 13, more preferably 8 to 12, most preferably 9.5 to 10.5 ethoxylates. The acid form or salt form, such as sodium or ammonium salt, may be used, and the alkyl chain may contain one cis or trans double bond. Alkyl ether carboxylic acids are available from Kao (Akypo®), Huntsman (Empicol®) and Clariant (Emulsogen®).

Other suitable anionic surfactants include the class of glycolipids, such as sophorolipids and rhamnolipids and amino acid based surfactants, e.g., acyl glycinates, acyl sarcosinates, acyl glutamates, and acyl taurates. The rhamnolipids may have a single rhamnose sugar ring or two rhamnose sugar rings.

The liquid detergent composition may also be substantially free of or free of anionic alkyl sulphate surfactant, anionic alkyl ethoxylated surfactant, anionic alkyl ethoxylated sulphate surfactant, or a combination thereof.

The liquid detergent composition may also include suitable cationic surfactants. The cationic surfactant may be included at a level of about 0.1% to about 2.0%. In addition, the composition can include from about 0.1% to about 1.8%, from about 0.2% to about 1.6%, from about 0.2% to about 1.4 from about 0.2% to about 1.2%, from about 0.2% to about 1.0%, from about 0.2% to about 0.8%, from about 0.2% to about 0.7%, or from about 0.2% to about 0.5%, by weight of the composition of a cationic surfactant. Examples of suitable cationic surfactants include alkyl pyridinium compounds, alkyl quaternary ammonium compounds, alkyl quaternary phosphonium compounds, alkyl ternary sulphonium compounds, and mixtures thereof.

One type of cationic surfactant is a quaternary ammonium compound having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides, preferably chloride; sulphate; and sulphonate.

Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulphate; 1,2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulphate; 1-methyl-1-stearoylamidoethyl-2-stearoylimidazolinium methylsulphate; 1-tallowyl amidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

The liquid detergent composition may also include suitable amphoteric or zwitterionic surfactants. These can include, for example, amine oxide and/or betaine. The amphoteric and/or zwitterionic surfactant may be included at a level of about 0.05% to about 2.0%. In addition, the composition can include from about 0.1% to about 1.9%, from about 0.1% to about 1.8%, from about 0.1% to about 1.7%, from about 0.1% to about 1.5%, from about 0.1% to about 1.4%, from about 0.1% to about 1.3%, from about 0.1% to about 1.2%, from about 0.1% to about 1.1%, from about 0.1% to about 1.0%, or from about 0.1% to about 0.5%, by weight of the composition of a zwitterionic and/or amphoteric surfactant.

Preferred amine oxides are alkyl dimethyl amine oxide or alkyl amido propyl dimethyl amine oxide, more preferably alkyl dimethyl amine oxide and especially coco dimethyl amine oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides.

Other suitable surfactants include betaines, such as alkyl betaines, alkylamidobetaine, amidazoliniumbetaine, sulfobetaine (INCI Sultaines) as well as Phosphobetaines.

### Solvents

A liquid detergent composition may include water. A liquid detergent composition may comprise from about 20% to about 99%, by weight of the composition of water. The water may be included at a level of about 20% to about 98%. In addition, the composition can include from about 25% to about 90%, from about 30% to about 90%, from about 40% to about 90%, from about 50% to about 90%, from about 60% to about 90%, from about 70% to about 90%, or from about 75% to about 90%, by weight of the composition of water.

A liquid detergent composition may comprise a non-water solvent. A liquid detergent composition may optionally comprise an organic solvent. Suitable organic solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. Preferred organic solvents include 1,2-propanediol, 2,3 butane diol, ethanol, glycerol, ethoxylated glycerol, dipropylene glycol, methyl propane diol and mixtures thereof 2 ethyl hexanol, 3,5,5,trimethyl-1 hexanol, and 2 propyl heptanol. Solvents may be a polyethylene or polypropylene glycol ether of glycerin. Other lower alcohols, C1-C4 alkanolamines such as monoethanolamine and triethanolamine, can also be used. These organic solvents may be used in conjunction with water, or they may be used without water.

### Adjuncts

A liquid detergent composition may include an adjunct ingredient. The adjunct ingredient may be selected based on the intended use of the liquid detergent composition. An adjunct ingredient may be included in a liquid detergent composition at a level of about 0.05% to about 30%, by weight of the composition. Some examples of adjunct ingredients include shading dye, leuco colorant diluent, aesthetic colorant, encapsulate, perfume, polymer, dye transfer inhibitor, oligoamine, etheramine, enzyme, bleaching agent, builder, organic acid, chelating agent, brightener, enzyme stabilizer, conditioning agent, probiotic, pearlescent, opacifier, hydrotrope, antioxidant, hygiene agent, or a combination thereof.

Shading Dye

A liquid detergent composition may include a shading dye. The dye may be used to shade fabric. Fabric shading can be accomplished through application of any suitable ingredient as known in the art. Preferred fabric shading agents include fabric shading dyes, leuco dyes, pigments and mixtures thereof.

Fabric shading can lead to whiteness improvements and can be accomplished through application of leuco dyes via use of a single compound or a leuco composition comprising at least one leuco compound comprising any suitable leuco moiety. In one aspect, the leuco moiety is selected from the group consisting of diarylmethane leuco moieties, triarylmethane leuco moieties, oxazine moieties, thiazine moieties, hydroquinone moieties, arylaminophenol moieties, and combinations thereof. The leuco compound may comprise a leuco moiety and an alkyleneoxy moiety covalently bound to the leuco moiety, wherein the alkyleneoxy moiety comprises at least one ethylene oxide group, preferably the alkylene oxide moiety also comprises at least one propylene oxide group. In one aspect, preferred leuco compounds include those conforming to the structure of Formula (CVIII),

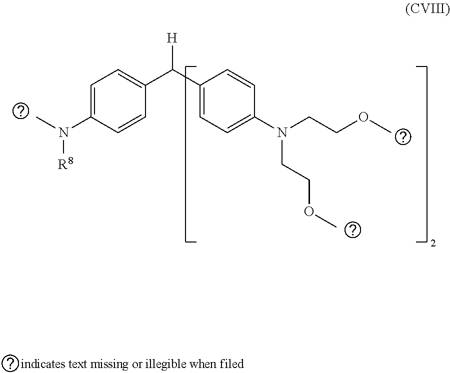

wherein R⁸ is H or CH₃ and each index b is independently on average about 1 to 2. Other suitable leuco dyes are disclosed in U.S. Pat. Nos. 10,377,976, 10,377,977, 10,351,709, 10,385,294, 10,472,595, 10,479,961, 10,501,633, 10,577,570, 10,590,275, 10,633,618, 10,647,854, and 10,676,699, incorporated in their entirety herein by reference.

The composition may comprise an additional fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Color Index (C.I.) classifications of Direct Blue, Direct Red, Direct Violet, Acid Blue, Acid Red, Acid Violet, Basic Blue, Basic Violet and Basic Red, or mixtures thereof. Preferred dyes include alkoxylated azothiophenes, Solvent Violet 13, Acid Violet 50 and Direct Violet 9.

Leuco Colorant Diluent

Another class of ingredients in the leuco colorants composition may be a diluent and/or solvent. The purpose of the diluent and/or solvent is often, but not limited to, improving fluidity and/or reducing the viscosity of the leuco colorant. Although water is often the preferred diluent and/or solvent given its low cost and non-toxicity, other solvent may also be used as well. The preferred solvent is one having low cost and low hazards. Examples of suitable solvents include, but are not limited to, ethylene glycol, propylene glycol, glycerin, alkoxylated polymers such as polyethylene glycol, polypropylene glycol, copolymers of ethylene oxide and propylene oxide, Tween 20®, Tween 40®, Tween 80®, and the like, and combinations thereof. Among the polymers, the ethylene oxide and propylene oxide copolymers may be preferred. These polymers often feature a cloud point with water, which can help the product separated from the water to remove the undesirable water-soluble impurities. Examples of ethylene oxide and propylene oxide copolymers include but not limited to the PLURONIC series polymers by BASF and TERGITOL™ series polymer and by Dow. When the leuco colorant composition is incorporated into the laundry care composition, these polymers may also act as a non-ionic surfactant.

Aesthetic Colorants

The composition may comprise one or more aesthetic colorants. Suitable aesthetic colorants can include dyes, dye-clay conjugates, pigments, and Liquitint® polymeric colorants (Milliken & Company, Spartanburg, South Carolina, USA). In one aspect, suitable dyes and pigments include small molecule dyes and polymeric dyes. The aesthetic colorant may include at least one chromophore constituent selected from the group consisting of acridines, anthraquinones, azines, azos, benzofurans, benzodifuranones, carotenoids, coumarins, cyanines, diazahemicyanines, diphenylmethanes, formazans, hemicyanines, indigoids, methanes, methines, naphthalimides, naphthoquinones, nitros, nitrosos, oxazines, phenothiazine, phthalocyanines (such as copper phthalocyanines), pyrazoles, pyrazolones, quinolones, stilbenes, styryls, triarylmethanes (such as triphenylmethanes), xanthenes, and mixtures thereof.

In one aspect of the invention, aesthetic colorants include Liquitint® Blue AH, Liquitint® Blue BB, Liquitint® Blue 275, Liquitint® Blue 297, Liquitint® Blue BB, Cyan 15, Liquitint® Green 101, Liquitint® Orange 272, Liquitint® Orange 255, Liquitint® Pink AM, Liquitint® Pink AMC, Liquitint® Pink ST, Liquitint® Violet 129, Liquitint® Violet LS, Liquitint® Violet 291, Liquitint® Yellow FT, Liquitint® Blue Buf, Liquitint® Pink AM, Liquitint® Pink PV, Acid Blue 80, Acid Blue 182, Acid Red 33, Acid Red 52, Acid Violet 48, Acid Violet 126, Acid Blue 9, Acid Blue 1, and mixtures thereof.

Encapsulates

The composition may comprise an encapsulated material. In one aspect, an encapsulate comprising a core, a shell having an inner and outer surface, said shell encapsulating said core. The core may comprise any laundry care adjunct, though typically the core may comprise material selected from the group consisting of perfumes; brighteners; hueing dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinyl alcohols, optionally containing other co-monomers; polystyrenes; polyisoprenes; polycarbonates; polyesters; polyacrylates; aminoplasts, in one aspect said aminoplasts may comprise a polyurea, polyurethane, and/or polyurea urethane, in one aspect said polyurea may comprise polyoxymethylene urea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

Preferred encapsulates comprise perfume. Preferred encapsulates comprise a shell which may comprise melamine formaldehyde and/or crosslinked melamine formaldehyde. Other preferred capsules comprise a polyacrylate based shell. Preferred encapsulates comprise a core material and a shell, said shell at least partially surrounding said core material, is disclosed. At least 75%, 85% or even 90% of said encapsulates may have a fracture strength of from 0.2 MPa to 10 MPa, and a benefit agent leakage of from 0% to 20%, or even less than 10% or 5% based on total initial encapsulated benefit agent. Preferred are those in which at least 75%, 85% or even 90% of said encapsulates may have (i) a particle size of from 1 microns to 80 microns, 5 microns to 60 microns, from 10 microns to 50 microns, or even from 15 microns to 40 microns, and/or (ii) at least 75%, 85% or even 90% of said encapsulates may have a particle wall thickness of from 30 nm to 250 nm, from 80 nm to 180 nm, or even from 100 nm to 160 nm. Formaldehyde scavengers may be employed with encapsulates, for example, in a capsule slurry and/or added to a composition before, during or after the encapsulates are added to such composition. Suitable capsules that can be made by following the teaching of USPA 2008/0305982 A1; and/or USPA 2009/0247449 A1. Alternatively, suitable capsules can be purchased from Appleton Papers Inc. of Appleton, Wisconsin USA.

In a preferred aspect the composition may comprise a deposition aid, preferably in addition to encapsulates. Preferred deposition aids are selected from the group consisting of cationic and nonionic polymers. Suitable polymers include cationic starches, cationic hydroxyethyl cellulose, polyvinyl formaldehyde, locust bean gum, mannans, xyloglucans, tamarind gum, polyethylene terephthalate and polymers containing dimethyl aminoethyl methacrylate, optionally with one or more monomers selected from the group comprising acrylic acid and acrylamide.

Perfume

A liquid detergent composition may comprise perfume. Typically, the composition comprises a perfume that comprises one or more perfume raw materials, selected from the group as described in WO08/87497. However, any perfume useful in a laundry care composition may be used. A preferred method of incorporating perfume into the compositions of the invention is via an encapsulated perfume particle comprising either a water-soluble hydroxylic compound or melamine-formaldehyde or modified polyvinyl alcohol.

Polymers

The composition may comprise one or more polymers. Examples are optionally modified carboxymethylcellulose, modified polyglucans, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The composition may comprise one or more amphiphilic cleaning polymers. Such polymers have balanced hydrophilic and hydrophobic properties such that they remove grease particles from fabrics and surfaces. Suitable amphiphilic alkoxylated grease cleaning polymers comprise a core structure and a plurality of alkoxylate groups attached to that core structure. These may comprise alkoxylated polyalkylenimines, especially ethoxylated polyethylene imines or polyethyleneimines having an inner polyethylene oxide block and an outer polypropylene oxide block. Typically, these may be incorporated into the compositions of the invention in amounts of from 0.005 to 10 wt %, generally from 0.5 to 8 wt %.

Zwitterionic Polyamine

The composition may comprise a zwitterionic polyamine that is a modified hexamethylenediamine. The modification of the hexamethylenediamine includes: (1) one or two alkoxylation modifications per nitrogen atom of the hexamethylenediamine. The alkoxylation modification consisting of the replacement of a hydrogen atom on the nitrogen of the hexamethylenediamine by a (poly)alkoxylene chain having an average of about 1 to about 40 alkoxy moieties per modification, wherein the terminal alkoxy moiety of the alkoxylene chain is capped with hydrogen, a C1-C4 alkyl, sulphates, carbonates, or mixtures thereof; (2) a substitution of one C1-C4 alkyl moiety and one or two alkoxylation modifications per nitrogen atom of the hexamethylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C₁-C₄ alkyl or mixtures thereof; or (3) a combination thereof.

Amphiphilic Graft Copolymer

Other suitable polymers include amphiphilic graft copolymers. Preferred amphiphilic graft co-polymer(s) comprise (i) polyethylene glycol backbone; and (ii) and at least one pendant moiety selected from polyvinyl acetate, polyvinyl alcohol and mixtures thereof. An example of amphiphilic graft co-polymer is Sokalan HP22, supplied from BASF. Other suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is preferably about 6000 and the weight ratio of the polyethylene oxide to polyvinyl acetate is about 40 to 60 and less than or equal to 1 grafting point per 50 ethylene oxide units. Typically, these are incorporated into the compositions of the invention in amounts from 0.005 to 10 wt %, more usually from 0.05 to 8 wt %.

Soil Release Polymers

The composition may comprise one or more soil release polymers. Examples include soil release polymers having a structure as defined by one of the following Formula (VI), (VII) or (VIII):

—[(OCHR¹—CHR²)ₐ—O—OC—Ar—CO—]_{d} (VI)

—[(OCHR³—CHR⁴)_{b}—O—OC-sAr—CO—]ₑ (VII)

—[(OCHR⁵—CHR⁶)ₑ—OR⁷]_{f} (VIII)

wherein: a, b and c are from 1 to 200; d, e and f are from 1 to 50; Ar is a 1,4-substituted phenylene; sAr is 1,3-substituted phenylene substituted in position 5 with SO₃Me; Me is Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof; R¹, R², R³, R⁴, R⁵ and R⁶ are independently selected from H or C₁-C₁₈ n- or iso-alkyl; and R⁷ is a linear or branched C₁-C₁₈ alkyl, or a linear or branched C₂-C₃₀ alkenyl, or a cycloalkyl group with 5 to 9 carbon atoms, or a C₅-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN260, SRN300 and SRN325 supplied by Clariant. Other suitable soil release polymers are Marloquest polymers, such as Marloquest SL supplied by Sasol.

Known polymeric soil release agents, hereinafter “SRA” or “SRA's”, can optionally be employed in the present detergent compositions. If utilized, SRA's will generally comprise from 0.01% to 10.0%, typically from 0.1% to 5%, preferably from 0.2% to 3.0% by weight, of the composition.

Carboxylate Polymer

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Alternatively, these materials may comprise polyacrylates having one ethoxy side-chain per every 7-8 acrylate units. The side-chains are of the formula —(CH₂CH₂O)ₘ (CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

Such carboxylate based polymers can advantageously be utilized at levels from about 0.1% to about 7%, by weight, in the compositions herein, Suitable polymeric dispersing agents include carboxylate polymer such as a maleate/acrylate random copolymer or polyacrylate homopolymer. Preferably the carboxylate polymer is a polyacrylate homopolymer having a molecular weight of from 4,000 Daltons to 9,000 Daltons, or maleate/acrylate copolymer with a molecular weight 60,000 Daltons to 80,000 Daltons. Polymeric polycarboxylates and polyethylene glycols, can also be used. Polyalkylene glycol-based graft polymer may prepared from the polyalkylene glycol-based compound and the monomer material, wherein the monomer material includes the carboxyl group-containing monomer and the optional additional monomer(s). Optional additional monomers not classified as a carboxyl group-containing monomer include sulfonic acid group-containing monomers, amino group-containing monomers, allylamine monomers, quaternized allylamine monomers, N vinyl monomers, hydroxyl group-containing monomers, vinylaryl monomers, isobutylene monomers, vinyl acetate monomers, salts of any of these, derivatives of any of these, and mixtures thereof.

Alkoxylated Polyamine-Based Polymers

The composition may comprise alkoxylated polyamines Such materials include but are not limited to ethoxylated polyethyleneimine, ethoxylated hexamethylene diamine, and sulphated versions thereof. Polypropoxylated derivatives are also included. A wide variety of amines and polyalkyleneimines can be alkoxylated to various degrees, and optionally further modified to provide the abovementioned benefits. A useful example is 600 g/mol polyethyleneimine core ethoxylated to 20 EO groups per NH. A preferred ethoxylated polyethyleneimine is PE-20 available from BASF.

Useful alkoxylated polyamine based polymers include the alkoxylated polyethylene imine type where said alkoxylated polyalkyleneimine has a polyalkyleneimine core with one or more side chains bonded to at least one nitrogen atom in the polyalkyleneimine core, wherein said alkoxylated polyalkyleneimine has an empirical formula (I) of (PEI)ₐ-(EO)_{b}-R₁, wherein a is the average number-average molecular weight (MW_{PEI}) of the polyalkyleneimine core of the alkoxylated polyalkyleneimine and is in the range of from 100 to 100,000 Daltons, wherein b is the average degree of ethoxylation in said one or more side chains of the alkoxylated polyalkyleneimine and is in the range of from 5 to 40, and wherein R₁ is independently selected from the group consisting of hydrogen, C₁-C₄ alkyls, and combinations thereof.

Other suitable alkoxylated polyalkyleneimine include those wherein said alkoxylated polyalkyleneimine has a polyalkyleneimine core with one or more side chains bonded to at least one nitrogen atom in the polyalkyleneimine core, wherein the alkoxylated polyalkyleneimine has an empirical formula (II) of (PEI)ₒ-(EO)ₘ(PO)ₙ—R₂ or (PEI)ₒ-(PO)ₙ(EO)ₘ-R₂, wherein o is the average number-average molecular weight (MW_{PEI}) of the polyalkyleneimine core of the alkoxylated polyalkyleneimine and is in the range of from 100 to 100,000 Daltons, wherein m is the average degree of ethoxylation in said one or more side chains of the alkoxylated polyalkyleneimine which ranges from 10 to 50, wherein n is the average degree of propoxylation in said one or more side chains of the alkoxylated polyalkyleneimine which ranges from 1 to 50, and wherein R₂ is independently selected from the group consisting of hydrogen, C₁-C₄ alkyls, and combinations thereof.

Cellulosic Polymer

Cellulosic polymers may be included in a liquid detergent composition. Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45, e.g. as described in WO09/154933.

The consumer products of the present invention may also include one or more cellulosic polymers including those selected from alkyl cellulose, alkylalkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da. Examples of carboxymethylcellulose polymers are Carboxymethyl cellulose commercially sold by CPKelko as Finnfix®GDA, hydrophobically modified carboxymethyl cellulose, for example the alkyl ketene dimer derivative of carboxymethylcellulose sold commercially by CPKelco as Finnfix®SH1, or the blocky carboxymethylcellulose sold commercially by CPKelco as Finnfix®V.

Cationic Polymers:

Cationic polymers may also be used according to the invention. Suitable cationic polymers will have cationic charge densities of at least 0.5 meq/gm, in another embodiment at least 0.9 meq/gm, in another embodiment at least 1.2 meq/gm, in yet another embodiment at least 1.5 meq/gm, but in one embodiment also less than 7 meq/gm, and in another embodiment less than 5 meq/gm, at the pH of intended use of the composition, which pH will generally range from pH 3 to pH 9, in one embodiment between pH 4 and pH 8. Herein, “cationic charge density” of a polymer refers to the ratio of the number of positive charges on the polymer to the molecular weight of the polymer. The average molecular weight of such suitable cationic polymers will generally be between 10,000 and 10 million, in one embodiment between 50,000 and 5 million, and in another embodiment between 100,000 and 3 million.

Suitable cationic polymers for use in the compositions of the present invention contain cationic nitrogen-containing moieties such as quaternary ammonium or cationic protonated amino moieties. Any anionic counterions can be used in association with the cationic polymers so long as the polymers remain soluble in water, in the composition, or in a coacervate phase of the composition, and so long as the counterions are physically and chemically compatible with the essential components of the composition or do not otherwise unduly impair product performance, stability or aesthetics. Nonlimiting examples of such counterions include halides (e.g., chloride, fluoride, bromide, iodide), sulphate and methylsulphate.

Nonlimiting examples of such polymers are described in the CTFA Cosmetic Ingredient Dictionary, 3rd edition, edited by Estrin, Crosley, and Haynes, (The Cosmetic, Toiletry, and Fragrance Association, Inc., Washington, D.C. (1982)).

Suitable cationic polymers are described in U.S. Pat. Nos. 3,962,418; 3,958,581; and U.S. Publication No. 2007/0207109A1.

Dye Transfer Inhibitor (DTI)

The composition may comprise one or more dye transfer inhibiting agents. In one embodiment of the invention the inventors have surprisingly found that compositions comprising polymeric dye transfer inhibiting agents in addition to the specified dye give improved performance. This is surprising because these polymers prevent dye deposition. Suitable dye transfer inhibitors include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. Suitable examples include PVP-K15, PVP-K30, ChromaBond S-400, ChromaBond S-403E and Chromabond S-100 from Ashland Aqualon, and Sokalan HP165, Sokalan HP50, Sokalan HP53, Sokalan HP59, Sokalan® HP 56K, Sokalan® HP 66 from BASF. The dye control agent may be selected from (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazine monomer compounds; and (vi) combinations thereof. Other suitable DTIs are as described in WO2012/004134. When present in a subject composition, the dye transfer inhibiting agents may be present at levels from about 0.0001% to about 10%, from about 0.01% to about 5% or even from about 0.1% to about 3% by weight of the composition.

Oligoamines

Non-limiting examples of amines include, but are not limited to, etheramines, cyclic amines, polyamines, oligoamines (e.g., triamines, diamines, pentamines, tetraamines), or combinations thereof. The compositions described herein may comprise an amine selected from the group consisting of oligoamines, etheramines, cyclic amines, and combinations thereof. In some aspects, the amine is not an alkanolamine. In some aspects, the amine is not a poly alkyleneimine.

Examples of suitable oligoamines include Preferably the composition comprises oligoamines. Suitable oligoamines according to the present disclosure may include diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, 1,1,4,7,7-pentamethyl diethylenetriamine (M5-DETA), dipropylenetriamine (DPTA) or mixtures thereof most preferably diethylenetriamine (DETA). DETA may be preferred due to its low molecular weight and/or relatively low cost to produce.

Etheramines

The liquid detergent compositions described herein may contain an etheramine. The detergent compositions may contain from about 0.1% to about 10%, or from about 0.2% to about 5%, or from about 0.5% to about 4%, by weight of the composition, of an etheramine.

The etheramines of the present disclosure may have a weight average molecular weight of less than about grams/mole 1000 grams/mole, or from about 100 to about 800 grams/mole, or from about 200 to about 450 grams/mole, or from about 290 to about 1000 grams/mole, or from about 290 to about 900 grams/mole, or from about 300 to about 700 grams/mole, or from about 300 to about 450 grams/mole. The etheramines of the present invention may have a weight average molecular weight of from about 150, or from about 200, or from about 350, or from about 500 grams/mole, to about 1000, or to about 900, or to about 800 grams/mole.

### Enzymes.

The liquid detergent composition may comprise one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

Bleaching Agents

The liquid detergent composition may comprise one or more bleaching agents. Suitable bleaching agents other than bleaching catalysts include photo bleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent or mixtures of bleaching agents by weight of the subject composition. Examples of suitable bleaching agents include:

Builders

The liquid detergent composition may comprise one or more builders or a builder system. When a builder is used, the composition of the invention will typically comprise at least 1%, from 2% to 60% builder. It may be preferred that the composition comprises low levels of phosphate salt and/or zeolite, for example from 1 to 10 or 5 wt %. The composition may even be substantially free of strong builder; substantially free of strong builder means “no deliberately added” zeolite and/or phosphate. Typical zeolite builders include zeolite A, zeolite P and zeolite MAP. A typical phosphate builder is sodium tri-polyphosphate.

Organic Acid

The liquid detergent composition may comprise one or more organic acids. Organic acids can include, for example, acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof.

Chelating Agent

The liquid detergent composition may comprise a chelating agent and/or crystal growth inhibitor. Suitable molecules include copper, iron and/or manganese chelating agents and mixtures thereof. Suitable molecules include hydroxamic acids, aminocarboxylates, aminophosphonates, succinates, salts thereof, and mixtures thereof. Non-limiting examples of suitable chelants for use herein include ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, ethanoldiglycines, ethylenediaminetetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), N,N-Dicarboxymethyl glutamic acid (GLDA) and salts thereof, and mixtures thereof. Other nonlimiting examples of chelants of use in the present invention are found in U.S. Pat. Nos. 7,445,644, 7,585,376 and 2009/0176684A1. Other suitable chelating agents for use herein are the commercial DEQUEST series, and chelants from Monsanto, DuPont, and Nalco, Inc. Yet other suitable chelants include the pyridinyl N Oxide type.

Fluorescent Brightener

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by BASF), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by BASF). More preferably, the fluorescent brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt. The brighteners may be added in particulate form or as a premix with a suitable solvent, for example nonionic surfactant, propanediol.

### Enzyme Stabilizers.

The composition may preferably comprise enzyme stabilizers. Any conventional enzyme stabilizer may be used, for example by the presence of water-soluble sources of calcium and/or magnesium ions in the finished fabric and home care products that provide such ions to the enzymes. In case of aqueous compositions comprising protease, a reversible protease inhibitor, such as a boron compound including borate, or preferably 4-formyl phenylboronic acid, phenylboronic acid and derivatives thereof, or compounds such as calcium formate, sodium formate and 1,2-propane diol can be added to further improve stability.

### Probiotics:

The composition may comprise probiotics, such as those described in WO2009/043709.

### Pearlescent Agent:

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Opacifier:

In one embodiment, the composition might also comprise an opacifier. As the term is used herein, an “opacifier” is a substance added to a material in order to make the ensuing system opaque. In one preferred embodiment, the opacifier is Acusol, which is available from Dow Chemicals. Acusol opacifiers are provided in liquid form at a certain % solids level. As supplied, the pH of Acusol opacifiers ranges from 2.0 to 5.0 and particle sizes range from 0.17 to 0.45 um. In one preferred embodiment, Acusol OP303B and 301 can be used.

In yet another embodiment, the opacifier may be an inorganic opacifier. Preferably, the inorganic opacifier can be TiO₂, ZnO, talc, CaCO₃, and combination thereof. The composite opacifier-microsphere material is readily formed with a preselected specific gravity, so that there is little tendency for the material to separate.

### Hydrotrope:

The composition may optionally comprise a hydrotrope in an effective amount, i.e. from about 0% to 15%, or about 1% to 10%, or about 3% to about 6%, so that compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

### Anti-Oxidant:

The composition may contain an anti-oxidant. The antioxidant may be present in the composition from about 0.001 to about 2% by weight. Preferably the antioxidant is present at a concentration in the range 0.01 to 0.08% by weight. Mixtures of anti-oxidants may be used.

Anti-oxidants are substances as described in Kirk-Othmer (Vol. 3, page 424) and In Ullmann's Encyclopedia (Vol. 3, page 91).

One class of anti-oxidants used in the present invention is alkylated phenols, having the general formula:

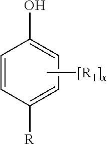

wherein R is C₁-C₂₂ linear or branched alkyl, preferably methyl or branched C₃-C₆ alkyl, C₁-C₆ alkoxy, preferably methoxy; R₁ is a C₃-C₆ branched alkyl, preferably tert-butyl; x is 1 or 2. Hindered phenolic compounds are a preferred type of alkylated phenols having this formula. Examples of such hindered phenol antioxidants may include, but are not limited to: 2,6-bis(1-methylpropyl)phenol; 2,6-bis(1,1-dimethylethyl)-4-methyl-phenol (also known as hydroxy butylated toluene, “BHT”); 2-(1,1-dimethylethyl)-1,4-benzenediol; 2,4-bis(1,1-dimethylethyl)-phenol; 2,6-bis(1,1-dimethylethyl)-phenol; 3,5-bis(1,1-dimethylethyl)-4-hydroxybenzene propanoic acid, methyl ester; 2-(1,1-dimethylethyl)-4-methylphenol; 2-(1,1-dimethylethyl)-4,6-dimethyl-phenol; 3,5-bis(1,1-dimethylethyl)-4-hydroxybenzenepropanoic acid, 1,1′-[2,2-bis[[3-[3,5-bis(1,1-dimethylethyl)-4-hydroxyphenyl]-1-oxopropoxy]methyl]-1,3-propanediyl] ester; 3,5-bis(1,1-dimethylethyl)-4-hydroxybenzenepropanoic acid, octadecyl ester; 2,2′-methylenebis [6-(1,1-dimethylethyl)-4-methylphenol; 2-(1,1-dimethylethyl)-phenol; 2,4,6-tris(1,1-dimethylethyl)-phenol; 4,4′-methylenebis[2,6-bis(1,1-dimethylethyl)-phenol; 4,4′,4″-[(2,4,6-trimethyl-1,3,5-benzenetriyl)tris(methylene)]tris[2,6-bis(1,1-dimethylethyl)-phenol]; N,N′-1,6-hexanediylbis[3,5-bis(1,1-dimethylethyl)-4-hydroxybenzenepropanamide; 3,5-bis(1,1-dimethylethyl)-4-hydroxy benzoic acid, hexadecyl ester; P-[[3,5-bis(1,1-dimethylethyl)-4-hydroxyphenyl]methylphosphonic acid, diethyl ester; 1,3,5-tris[[3,5-bis(1,1-dimethylethyl)-4-hydroxyphenyl]methyl]-1,3,5-Triazine-2,4,6(1H,3H,5H)-trione; 3,5-bis(1,1-5 dimethylethyl)-4-hydroxybenzenepropanoic acid, 2-[3-[3,5-bis(1,1-dimethylethyl)-4-hydroxyphenyl]-1-oxopropyl]hydrazide; 3-(1,1-dimethylethyl)-4-hydroxy-5-methylbenzenepropanoic acid, 1,1′-[1,2-ethanediylbis(oxy-2,1-ethanediyl)] ester; 4-[(dimethyl amino)methyl]-2,6-bis(1,1-dimethylethyl)phenol; 4-[[4,6-bis(octylthio)-1,3,5-triazin-2-yl]amino]-2,6-bis(1,1-dimethylethyl)phenol; 3,5-bis(1,1-dimethylethyl)-4-hydroxy benzene propanoic acid, 1,1′-(thiodi-2,1-ethanediyl) ester; 3,5-bi s (1,1-dimethylethyl)-4-hydroxybenzoic acid, 2,4-bis(1,1-dimethylethyl)phenyl ester; 3,5-bis(1,1-dimethylethyl)-4-hydroxybenzenepropanoic acid, 1,1′-(1,6-hexanediyl)ester; 3-(1,1-dimethylethyl)-4-hydroxy-5-methylbenzenepropanoic acid, 1,1′-[2,4,8,10-tetraoxaspiro[5.5]undecane-3,9-diylbis(2,2-dimethyl-2,1-ethanediyl)] ester; 3-(1,1-dimethylethyl)-b-[3-(1,1-dimethylethyl)-4-hydroxy phenyl]-4-hydroxy-b-methylbenzenepropanoic acid, 1,1′-(1,2-ethanediyl) ester; 2-[[3,5-bis(1,1-dimethylethyl)-4-hydroxyphenyl]methyl]-2-butylpropanedioic acid, 1,3-bis(1,2,2,6,6-pentamethyl-4-piperidinyl) ester; 3,5-bis(1,1-dimethylethyl)-4-hydroxybenzenepropanoic acid, 1-[2-[3-[3,5-bis(1,1-dimethylethyl)-4-hydroxyphenyl]-1-oxopropoxy]ethyl]-2,2,6,6-tetramethyl-4-piperidinyl ester; 3,4-dihydro-2,5,7,8-tetramethyl-2-[(4R,8R)-4,8,12-trimethyltridecyl]-(2R)-2H-1-benzopyran-6-ol; 2,6-dimethylphenol; 2,3,5-trimethyl-1,4-benzenediol; 2,4,6-trimethylphenol; 2,3,6-trimethylphenol; 4,4′-(1-methylethylidene)-bis[2,6-dimethylphenol]; 1,3,5-tris[[4-(1,1-dimethylethyl)-3-hydroxy-2,6-dimethylphenyl]methyl]-1,3,5-triazine-2,4,6(1H,3H,5H)-trione; 4,4′-methylenebis[2,6-dimethylphenol]; and mixtures thereof.

Preferably, the hindered phenol antioxidant comprises at least one phenolic —OH group having at least one C3-C6 branched alkyl at a position ortho to said at least one phenolic —OH group. More preferably, the hindered phenol antioxidant is an ester of 3,5-bis(1,1-dimethylethyl)-4-hydroxy-benzenepropanoic acid, and most preferably a C1-C22 linear alkyl ester of 3,5-bis(1,1-dimethylethyl)-4-hydroxy-benzenepropanoic acid. Commercially available C1-C22 linear alkyl esters of 3,5-bis(1,1-dimethylethyl)-4-hydroxy-benzenepropanoic acid include RALOX® from Raschig USA (Texas, USA), which is a methyl ester of 3,5-bis(1,1-dimethylethyl)-4-hydroxy-benzenepropanoic acid, and TINOGARD® TS from BASF (Ludwigshafen, Germany), which is an octadecyl ester of 3,5-bis(1,1-dimethylethyl)-4-hydroxy-benzenepropanoic acid.

Furthermore, the anti-oxidant used in the composition may be selected from the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Raluquin™ by the company Raschig™.

Other types of anti-oxidants that may be used in the composition are 6-hydroxy-2,5,7,8-tetramethylchroman-2-carboxylic acid (Trolox™) and 1,2-benzisothiazoline-3-one (Proxel GXL™).

A further class of anti-oxidants which may be suitable for use in the composition is a benzofuran or benzopyran derivative having the formula:

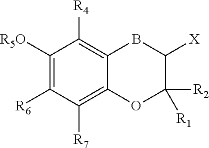

wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C(O)R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen comprising unit, phenyl, or substituted phenyl. Preferred nitrogen comprising A units include amino, pyrrolidino, piperidino, morpholino, piperazino, and mixtures thereof). The cleaning compositions of the present disclosure may comprise tannins selected from the group consisting of gallotannins, ellagitannins, complex tannins, condensed tannins, and combinations thereof.

Hygiene Agent

The liquid detergent compositions may also comprise components to deliver hygiene and/or malodor benefits. A hygiene agent may include, for example, zinc ricinoleate, thymol, quaternary ammonium salts such as Bardac®, polyethylenimines (such as Lupasol® from BASF) and zinc complexes thereof, silver and silver compounds, especially those designed to slowly release Ag+ or nano-silver dispersions.

The liquid detergent composition may also contain antimicrobial agents. Cationic active ingredients may include but are not limited to n-alkyl dimethyl benzyl ammonium chloride, alkyl dimethyl ethyl benzyl ammonium chloride, dialkyl dimethyl quaternary ammonium compounds such as didecyl dimethyl ammonium chloride, N,N-didecyl-N-methyl-poly(oxyethyl) ammonium propionate, dioctyl didecyl ammonium chloride, also including quaternary species such as benzethonium chloride, alkyl pyridinium chlorides, and quaternary ammonium compounds with inorganic or organic counter ions such as bromine, carbonate or other moieties including dialkyl dimethyl ammonium carbonates, as well as antimicrobial amines such as Chlorhexidine Gluconate, PHMB (Polyhexamethylene biguanide), salt of a biguanide, a substituted biguanide derivative, an organic salt of a quaternary ammonium containing compound or an inorganic salt of a quaternary ammonium containing compound or mixtures thereof. More Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

Example Liquid Detergent Formulations

| | Inventive | Inventive |
|---|---|---|
| Material, % Active | Formula 1 | Formula 2 |
| Water | Q.S. | Q.S. |
| Other adjuncts (ex. brightener, | 2.235 | 1.605 |
| aesthetic dye, perfume, | | |
| enzyme stabilizer, etc.) | | |
| Citric Acid | 0.55 | 0.92 |
| GLDA | 0.46 | 0.48 |
| MEA | 0.53 | 0.34 |
| NaOH | 0.36 | 0.44 |
| Propylene Glycol | 0.59 | 0.44 |
| NaCS | 0.41 | 0.45 |
| Inventive Nonionic surfactant | 8.03 | 8.64 |
| C12/C14 dimethyl amine oxide | 0.25 | 0.48 |
| HLAS | 2.59 | 3.15 |
| Total Surfactant | 10.87 | 12.27 |

The example compositions are prepared by combining all raw materials to achieve the composition. The raw materials are mixed rapidly to achieve a vortex with a mixing impeller for about 60 minutes to result in a stable one phase liquid.

### Combinations

A. A liquid detergent composition comprising:
a) from about 0.5% to about 15%, preferably 5.0% to about 15%, more preferably from about 9% to about 13%, by weight of the composition, of surfactant; wherein the surfactant comprises an anionic surfactant, and a nonionic alcohol ethoxylate surfactant with an average carbon chain length of about 13 to about 15 and an average level of ethoxylation of about 6.8 to about 8.25; and
b) water;
wherein the ratio by weight of the nonionic alcohol ethoxylate surfactant to the anionic surfactant is from about 0.8:1 to about 5:1, preferably from about 1.5:1 to about 4:1, more preferably from about 2.5:1 to about 3:1; and the viscosity of the liquid detergent composition is from 250 cP to about 800 cP, preferably from about 350 cP to about 800 cP, when measured at 25° C. at 20/s.
   B. The liquid detergent composition of paragraph A, wherein the anionic surfactant comprises an alkyl benzene sulfonate, preferably from about 1% to about 5%, more preferably from about 2% to about 4%, by weight of the composition of the alkyl benzene sulfonate.
   C. The liquid laundry detergent composition of paragraphs A-B, wherein the composition is free of an alkyl sulphate surfactant, an alkyl ethoxy sulphate surfactant, or a combination thereof.
   D. The liquid laundry detergent composition of paragraphs A-C, wherein the average carbon chain length of the nonionic alcohol ethoxylate has about 95% to 100% of chain lengths of C11 to C16.
   E. The liquid laundry detergent composition of paragraphs A-D, wherein the composition comprises from about 3% to about 13%, preferably about 7.5% to about 10%, by weight of the composition of the nonionic alcohol ethoxylate surfactant.
   F. The liquid laundry detergent composition of paragraphs A-E, wherein the nonionic alcohol ethoxylate has an average carbon chain length and a level of ethoxylation as follows: an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.
   G. The liquid laundry detergent composition of paragraphs A-F, wherein the surfactant further comprises an amine oxide surfactant, preferably from about 0.1% to about 1.0% by weight of the composition of the amine oxide.
   H. A liquid laundry detergent composition comprising:
a) from about 5% to about 15%, by weight of the composition, of surfactant; wherein the surfactant comprises:
   i) an anionic surfactant, preferably an alkyl benzene sulfonate, and
   ii) a nonionic alcohol ethoxylate surfactant with an average carbon chain length of about 13 to about 13.5 and an average level of ethoxylation of about 6.8 to about 7.5; a nonionic alcohol ethoxylate surfactant with an average carbon chain length of about 13.5 to about 14 and an average level of ethoxylation of about 6.8 to about 7.75; a nonionic alcohol ethoxylate surfactant with an average carbon chain length of about 14.25 to about 15 and an average level of ethoxylation of about 6.8 to about 8.2; and
b) water.
   I. The liquid laundry detergent composition of paragraph H, wherein the ratio by weight of the nonionic alcohol ethoxylate surfactant to the anionic surfactant is from about 1.5:1 to about 4:1, preferably from about 2.5:1 to about 3:1.
   J. The liquid laundry detergent composition of paragraphs H-I, wherein the average carbon chain length of the nonionic alcohol ethoxylate has about 95% to 100% of chain lengths of C11 to C16.
   K. The liquid laundry detergent composition of paragraphs H-J, wherein the nonionic alcohol ethoxylate has an average carbon chain length and a level of ethoxylation as follows: an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.
   L. The liquid detergent composition of paragraphs H-J, wherein the anionic surfactant comprises the alkyl benzene sulfonate, preferably from about 1% to about 5%, more preferably from about 2% to about 4%, by weight of the composition of the alkyl benzene sulfonate.
   M. The liquid laundry detergent composition of paragraphs H-L, wherein the composition comprises from about 3% to about 13%, preferably about 7.5% to about 10%, by weight of the composition of the nonionic alcohol ethoxylate surfactant.
   N. The liquid laundry detergent composition of paragraphs H-M, wherein the surfactant further comprises an amine oxide surfactant, preferably a C12/C14 dimethyl amine oxide.
   O. The liquid laundry detergent composition of paragraph N, wherein the composition comprises from about 0.1% to about 1.0% of the amine oxide.
   P. The liquid laundry composition of paragraphs H-O, wherein the composition is free of alkyl sulphate surfactant, alkyl ethoxy sulphate surfactant, or a combination thereof.
   Q. The liquid laundry detergent composition of paragraphs H-O, wherein the viscosity of the liquid detergent composition is from 250 cP to about 800 cP, preferably from about 350 cP to about 800 cP, when measured at 25° C. at 20/s.
   R. Use of a nonionic alcohol ethoxylate surfactant for increasing the viscosity of a liquid detergent composition, wherein the composition comprises from 0.5% to 15% by weight of surfactant.
   S. The use of paragraph R, wherein the nonionic alcohol ethoxylate surfactant comprises an average carbon chain length of about 13 to about 15 and an average level of ethoxylation of about 6.8 to about 8.25.
   T. The use of paragraphs R-S, wherein the nonionic alcohol ethoxylate has an average carbon chain length and a level of ethoxylation as follows: an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.
   U. The use of paragraphs R-T, wherein the surfactant further comprises an anionic surfactant.
   V. The use of paragraphs R-U, wherein the ratio by weight of the nonionic alcohol ethoxylate surfactant to the anionic surfactant is from about 0.8:1 to about 5:1, preferably from about 1.5:1 to about 4:1, more preferably from about 2.5:1 to about 3:1.
   W. The use of paragraphs R-V, wherein the viscosity of the liquid detergent composition is from 250 cP to about 800 cP, preferably from about 350 cP to about 800 cP, when measured at 25° C. at 20/s.
   X. The use of paragraphs U-W, wherein the anionic surfactant comprise an alkyl benzene sulfonate, preferably at a level of about 1% to about 5%, more preferably from about 2% to about 4%, by weight of the composition.
   Y. The use of paragraphs R-X, wherein the nonionic alcohol ethoxylate surfactant is at a level of 3% to about 13%, preferably about 7.5% to about 10%, by weight of the composition.
   Z. The use of paragraphs R-Y, wherein the nonionic alcohol ethoxylate surfactant comprises an average carbon chain length of about 14 to about 15 and an average level of ethoxylation of about 7, an average carbon chain length of about 14 to about 15 and an average level of ethoxylation of about 6.8, an average carbon chain length of about 15 and an average level of ethoxylation of about 7.
   AA. The use of paragraphs R-Z, wherein the surfactant further comprises an amine oxide surfactant, preferably a C12/C14 dimethyl amine oxide.
   BB. The use of paragraph AA, wherein the composition comprises from about 0.1% to about 1.0% of the amine oxide.
   CC. The use of paragraphs R-BB, wherein the composition is free of alkyl sulphate surfactant, alkyl ethoxy sulphate surfactant, or a combination thereof.
   DD. The use of paragraphs R-CC, wherein the composition further comprises citric acid, tetrasodium glutamate diacetate, monoethylamine, sodium hydroxide, sodium cumene sulfonate, or a combination thereof.
   EE. The use of paragraphs R-DD, wherein the nonionic alcohol ethoxylate surfactant comprises an average carbon chain length of about 13 to about 13.5 and an average level of ethoxylation of about 6.8 to about 7.5; an average carbon chain length of about 13.5 to about 14 and an average level of ethoxylation of about 6.8 to about 7.75; an average carbon chain length of about 14.25 to about 15 and an average level of ethoxylation of about 6.8 to about 8.2, or a combination thereof.

### Methods

Method for Measuring Viscosity

Viscosity can be measured utilizing an AR 550 rheometer from TA instruments. For non-structured liquids, the viscosity can be measured at a temperature of 25° C. utilizing a 2° plate at a speed of 20 revolutions per second (20/s). For structured liquids, a flat plate is used. This can be adjusted as needed based on the liquid being measured within the purview of one of skill in the art.

Method for Determining Nonionic with Viscosity Benefit

To help determine whether a nonionic alcohol ethoxylate can give a viscosity benefit, the nonionic alcohol ethoxylate surfactant in question can be substituted into the following formula:

| Material, % Active | testing formula |
|---|---|
| Water | Q.S. |
| Citric Acid | 0.55 |
| GLDA | 0.46 |
| MEA | 0.53 |
| NaOH | 0.36 |
| Propylene Glycol | 0.59 |
| NaCS | 0.41 |
| Nonionic alcohol ethoxylate surfactant | 8.03 |
| C12/C14 dimethyl amine oxide | 0.25 |
| HLAS | 2.59 |

The testing formula can be made as described above for the inventive formulas. After the testing formula is made its viscosity can be testing in accordance with the Method For Measuring Viscosity.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
a) from about 0.5% to about 15%, by weight of the composition, of a surfactant; wherein the surfactant comprises an anionic surfactant, and a nonionic alcohol ethoxylate surfactant with an average carbon chain length of about 13 to about 15 and an average level of ethoxylation of about 6.8 to about 8.25; and
b) water;
wherein the ratio by weight of the nonionic alcohol ethoxylate surfactant to the anionic surfactant is from about 0.8:1 to about 5:1 and the viscosity of the liquid detergent composition is from 250 cP to about 800 cP when measured at 25° C. at 20/s.

2. The liquid detergent composition of claim 1, wherein the ratio by weight of the nonionic alcohol ethoxylate surfactant to the anionic surfactant is from about 1.5:1 to about 4:1.

3. The liquid detergent composition of claim 1, wherein the ratio by weight of the nonionic alcohol ethoxylate surfactant to the anionic surfactant is from about 2.5:1 to about 3:1.

4. The liquid detergent composition of claim 1, wherein the anionic surfactant comprises a linear alkyl benzene sulfonate.

5. The liquid detergent composition of claim 4, wherein the composition comprises from about 1% to about 5% by weight of the linear alkyl benzene sulfonate.

6. The liquid laundry detergent composition of claim 1, wherein the composition has a viscosity of about 350 cP to about 800 cP.

7. The liquid laundry detergent composition of claim 6, wherein the composition is free of an alkyl sulphate surfactant and/or alkyl ethoxy sulphate.

8. The liquid laundry detergent composition of claim 1, wherein the average carbon chain length of the nonionic alcohol ethoxylate has about 95% to 100% of chain lengths of C11 to C16.

9. The liquid laundry detergent composition of claim 1, wherein the composition comprises from about 3% to about 13% of the nonionic alcohol ethoxylate surfactant.

10. A liquid laundry detergent composition comprising:
a) from about 5% to about 15%, by weight of the composition, of surfactant; wherein the surfactant comprises:
i) an anionic surfactant, and
ii) a nonionic alcohol ethoxylate surfactant with an average carbon chain length of about 13 to about 13.5 and an average level of ethoxylation of about 6.8 to about 7.5; a nonionic alcohol ethoxylate surfactant with an average carbon chain length of about 13.5 to about 14 and an average level of ethoxylation of about 6.8 to about 7.75; a nonionic alcohol ethoxylate surfactant with an average carbon chain length of about 14.25 to about 15 and an average level of ethoxylation of about 6.8 to about 8.2; and
b) water.

11. The liquid laundry detergent composition of claim 10, wherein the ratio by weight of the nonionic alcohol ethoxylate surfactant to the anionic surfactant is from about 1.5:1 to about 4:1.

12. The liquid laundry detergent composition of claim 11, wherein the anionic surfactant comprises a linear alkyl benzene sulfonate surfactant.

13. The liquid laundry detergent composition of claim 12, wherein the average carbon chain length of the nonionic alcohol ethoxylate has about 95% to 100% of chain lengths of C11 to C16.

14. The liquid laundry detergent composition of claim 12, wherein the nonionic alcohol ethoxylate has an average carbon chain length and a level of ethoxylation as follows: an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.

15. The liquid laundry detergent composition of claim 12, wherein the surfactant further comprises an amine oxide surfactant.

16. The liquid laundry detergent composition of claim 15, wherein the composition comprises from about 0.1% to about 1.0% of the amine oxide.

17. The liquid laundry composition of claim of claim 12, wherein the composition is free of alkyl sulphate surfactant, alkyl ethoxy sulphate, or a combination thereof.

18. A liquid laundry composition comprising:
a) from about 5% to about 15% by weight of the composition of surfactant, wherein the surfactant comprises: from about 3% to about 13% by weight of the composition of a nonionic alcohol ethoxylate surfactant with an average carbon chain length of about 13 to about 15 and an average level of ethoxylation of about 6.8 to about 8.25; from about 1% to about 5% by weight of the composition of a linear alkyl benzene sulfonate surfactant; and from about 0.1% to about 1% by weight of the composition of an amine oxide; and
b) water;
wherein the composition has a viscosity of about 350 cP to about 800 cP when measured at 25° C. at 20/s and the ratio by weight of the nonionic alcohol ethoxylate surfactant to the alkyl benzene sulfonate surfactant is from about 1.5:1 to about 4:1.

19. The liquid laundry detergent composition of claim 18, wherein the nonionic alcohol ethoxylate has an average carbon chain length and a level of ethoxylation as follows: an average level of ethoxylation of about 7.0 and an average carbon chain length of about 14.9; level of ethoxylation of about 7.0 and an average carbon chain length of about 14.7; level of ethoxylation of about 7.0 and an average carbon chain length of about 14.5; level of ethoxylation of about 7.0 and an average carbon chain length of about 14.4; level of ethoxylation of about 7.0 and an average carbon chain length of about 14.3, level of ethoxylation of about 7.0 and an average carbon chain length of about 14.1; level of ethoxylation of about 7.0 and an average carbon chain length of about 13.9; level of ethoxylation of about 7.0 and an average carbon chain length of about 13.7; level of ethoxylation of about 7.0 and an average carbon chain length of about 13.5; level of ethoxylation of about 7.0 and an average carbon chain length of about 13.0; level of ethoxylation of about 7.4 and an average carbon chain length of about 14.3; level of ethoxylation of about 7.4 and an average carbon chain length of about 14.7; level of ethoxylation of about 7.4 and an average carbon chain length of about 14.9; level of ethoxylation of about 7.6 and an average carbon chain length of about 14.4; level of ethoxylation of about 7.9 and an average carbon chain length of about 14.9; or a combination thereof.
